(19) United States
(12) Patent Application Publication
(10) Pub. No.: US 2026/0136290 A1
(43) Pub. Date: May 14, 2026

(54) INDICATION TO WAKE STATION OUT OF POWER SAVE

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(73) Assignee: Cisco Technology, Inc., San Jose, CA (US)

(21) Appl. No.: 19/383,344

(22) Filed: Nov. 7, 2025

Related U.S. Application Data
(60) Provisional application No. 63/800,251, filed on May 5, 2025.
(60) Provisional application No. 63/785,289, filed on Apr. 8, 2025.
(60) Provisional application No. 63/718,454, filed on Nov. 8, 2024.

(51) Int. Cl. H04W 52/02

(52) U.S. Cl. CPC H04W 52/0235

(57) ABSTRACT

Mechanisms for indicating and negotiating when Stations (STAs) should come out of power save (PS), including which link should come out of PS, may be provided. Enabling a device to make a link available during unavailability on a setup link can include sending to a client device a request to make a second link available when the client device is unavailable on a first link, wherein the client device is configured to switch a Station (STA) associated with the second link from a doze state to an awake state. An indication of an unavailability period on the first link is received, and the client device is communicated with using the second link during the unavailability period. After the unavailability period, the client device is communicated with using the first link.

### RELATED APPLICATION

Under provisions of 35 U.S.C. § 119(e), Applicant claims the benefit of and priority to U.S. Provisional Application No. 63/718,454, filed November 8, 2024, U.S. Provisional Application No. 63/785,289, filed April 8, 2025, and U.S. Provisional Application No. 63/800,251, filed May 5, 2025, the disclosures of which are incorporated herein by reference in their entirety.

### TECHNICAL FIELD

The present disclosure relates generally to mechanisms for indicating and negotiating when Stations (STAs) should come out of power save (PS), including which link should come out of PS.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing indications and negotiating for a device to come out of power save (PS) in accordance with aspects of the present disclosure.

FIG. 2 is a block diagram of an example multi-link operation (MLO) in accordance with aspects of the present disclosure.

FIG. 3 is a signal process of a client device making another link available during unavailability periods of a setup link in accordance with aspects of the present disclosure.

FIG. 4 is another signal process of a client device making another link available during unavailability periods of a setup link in accordance with aspects of the present disclosure.

FIG. 5 is a block diagram of an example Initial Control Response (ICR) in accordance with aspects of the present disclosure.

FIG. 6 is a signal process of a client device making another link available during unavailability periods of a setup link for a transmit opportunity in accordance with aspects of the present disclosure.

FIG. 7 is a flow chart of a method for providing indications and negotiating for a device to come out of PS in accordance with aspects of the present disclosure.

FIG. 8 is a block diagram of a computing device in accordance with aspects of the present disclosure.

FIG. 9 is a block diagram of a computing device in accordance with aspects of the present disclosure.

### DETAILED DESCRIPTION

### OVERVIEW

Mechanisms for indicating and negotiating when Stations (STAs) should come out of power save (PS), including which link should come out of PS, may be provided. Enabling a device to make a link available during unavailability on a setup link can include sending to a client device a request to make a second link available when the client device is unavailable on a first link, wherein the client device is configured to switch a Station (STA) associated with the second link from a doze state to an awake state. An indication of an unavailability period on the first link is received, and the client device is communicated with using the second link during the unavailability period. After the unavailability period, the client device is communicated with using the first link.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11 standard has evolved from a single radio to a multi-radio technology. For example, the IEEE 802.11be amendments introduced multi-link operation (MLO) features. MLO generally involves data transmission and/or reception using multiple links to one or more devices. MLO generally functions by distributing data across several frequency bands or channels, such as 2.4 GHz, 5 GHz, and/or 6 GHz. A non-Access Point (AP) multi-link device (MLD) may connect to one or more APs simultaneously through two or more separate links. For example, the non-AP MLD may utilize a first link on the 2.4 GHz band for use with stable and less-sensitive services and a second link on the 5 GHz band for some high-speed and latency-sensitive services such as video games, virtual reality, video conferencing, and so on. A non-AP MLD can maintain both connections concurrently, thereby optimizing the overall experience.

A non-AP MLD may use more power when multiple links are active and multiple radios are used compared to when using a single link and single radio. To reduce power consumption when maintaining multiple links, a non-AP MLD can put one or more links not currently in use into a power save (PS) mode. Each link of a non-AP MLD can use an independent power management mechanism or otherwise be able to set each link in an active or PS mode independently from the other links. A link in the active mode is “awake” for transmitting and receiving data frames. A link in the PS mode can be in a “doze” or “asleep” mode where no data can be received or transmitted via the link to save energy.

A non-AP MLD may become unavailable for traffic exchange on a link due to in-device coexistence (IDC) constraints. For example, a non-AP MLD may perform another short-range wireless traffic exchange on the same 2.4GHz band, leading to IDC interference and preventing the exchange of traffic (e.g., Media Access Control (MAC) Protocol Data Units (MPDUs)) on the 2.4 GHz Wi-Fi channel. Due to radio hardware constraints, when a non-AP MLD is performing other wireless technology traffic exchange (e.g. using Bluetooth or Ultra-wideband (UWB) technology) on channels which are used for Wi-Fi, the non-AP MLD may not be available to exchange traffic on Wi-Fi channels. A non-AP MLD may also have peer-to-peer traffic exchanged via the same radio or link that can cause interference, also causing the non-AP MLD to be unavailable for communicating via the Wi-Fi link.

To address periods of unavailability on an active link caused by IDC, peer-to-peer communications, or otherwise, an AP-MLD and a non-AP MLD can communicate using another link. However, the other link may be in a PS mode, such as when the non-AP MLD is not actively using the link. The non-AP MLD, therefore, must know when to switch the other link from a PS mode to an active mode (e.g., switch the associated STA from a doze state to an awake state) to enable communicating via the other link. To enable communication on the other link when desired or otherwise needed, an AP MLD can request a non-AP MLD to come out of PS on another link when the non-AP MLD indicates its unavailability for a link. The AP MLD can use these mechanisms to meet requirements for Quality of Service (QoS) traffic flows even when the non-AP MLD is unavailable on a link.

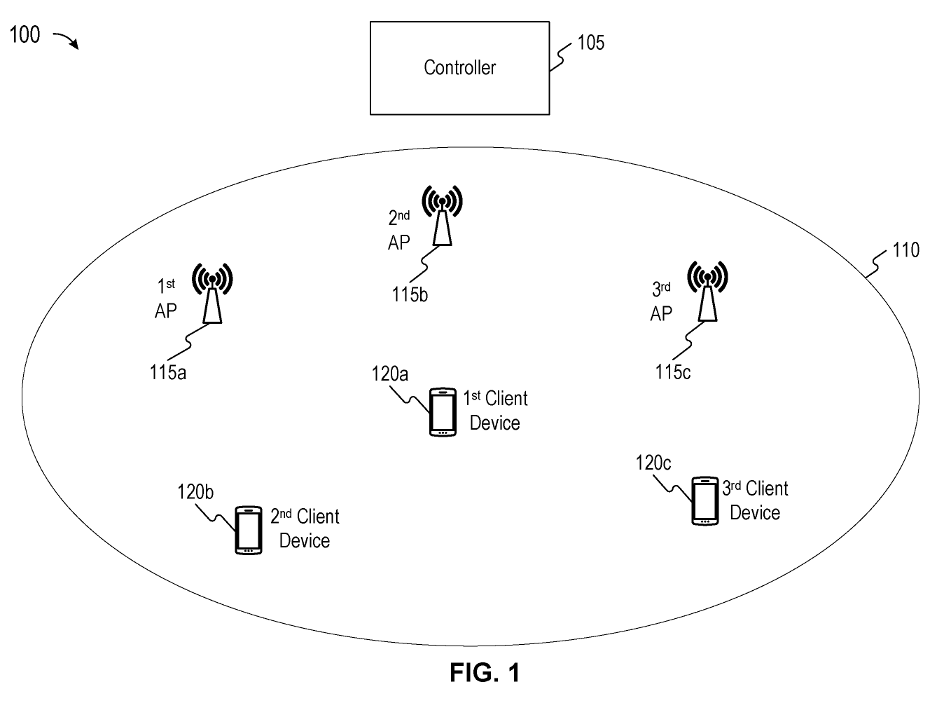

FIG. 1 is a block diagram of an operating environment 100 for providing indications for a device to come out of PS. In the illustrated embodiment, the operating environment 100 comprises a controller 105 and a coverage environment 110. The coverage environment 110 can comprise, but is not limited to, a Wireless Local Area Network (WLAN) comprising a plurality of APs 115 that may provide wireless network access, such as access to the WLAN for client devices 120. The plurality of APs 115 (e.g., AP Stations (STAs)) may comprise a first AP 115 a, a second AP 115 b, and a third AP 115 c. The APs 115 may be AP MLDs and provide wireless network access to a plurality of client devices 120 as they move within coverage environment 110. The plurality of client devices 120 (e.g., non-AP STAs) may comprise a first client device 120 a, a second client device 120 b, and a third client device 120 c.

The client devices 120 may be any non-AP MLD, such as a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, a server, or other similar microcomputer-based device. Each of the APs 115 may be compatible with specification standards such as the IEEE 802.11 specification standard.

The controller 105 may comprise a Wireless Local Area Network (WLAN) controller (WLC) and may provision and control coverage environment 110 (e.g., a WLAN). The controller 105 may enable the first client device 120 a, the second client device 120 b, and the third client device 120 c to join the coverage environment 110.

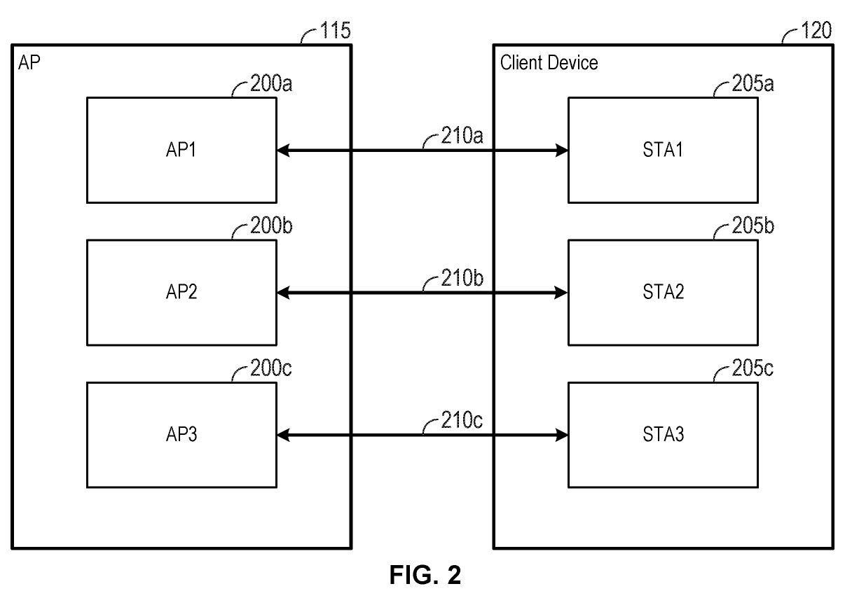

FIG. 2 is a block diagram of an example MLO. The plurality of APs 115 and the plurality of client devices 120 may use MLO where a client device 120 (i.e., a non-AP MLD) can setup two or more links 210 with an AP 115 (i.e., an AP MLD) as part of the association process. Based on the mode of operation and client capabilities, a client device 120 may choose to simultaneously transmit and receive across different setup links/bands (e.g., using the simultaneous transmit and receive (STR) MLO mode) or may choose to use one of the setup links for transmit and receive with the AP 115 (e.g., using the multi-link single-radio (MLSR) MLO mode or the enhanced MLSR (EMLSR) MLO mode). These links/bands may comprise, but are not limited to, the 2.4 GHz band, the 5 GHz band, the 6 GHz band, and the 60 GHz band. The two or more links on any given one of the plurality of client devices may be made with any one AP 115 or with any combination of the APs (e.g., with the first AP 115 a, the second AP 115 b, and/or the third AP 115 c).

In the illustrated embodiment, a client device 120 (e.g., a non-AP MLD) has multiple links to an AP 115 (e.g., an AP MLD). The AP 115 can include a plurality of affiliated APs, for example, including AP1 200 a, AP2 200 b, and AP3 200 c. The client device 120 can include multiple affiliated STAs, such as STA1 205 a, STA2 205 b, and STA3 205 c. In some embodiments, a client device 120 can perform MLO with a single STA 205, such as by using MLSR or EMLSR MLO techniques. As shown in FIG. 2, a first link 210 a between the AP 115 and the client device 120 is setup via the AP1 200 a and the STA1 205 a. A second link 210 b between the AP 115 and the client device 120 is setup via the AP2 200 b and the STA2 205 b. A third link 210 a between the AP 115 and the client device 120 is setup via the AP3 200 c and the STA3 205 c.

The client devices 120 can indicate upcoming periods of unavailability for a specific setup link (e.g., due to IDC, peer-to-peer communications, etc.) to its associated AP, which then allows the AP to not attempt to transmit to the non-AP MLD during the unavailability periods indicated. However, when a client device becomes unavailable on an active link, the AP may still have latency-sensitive traffic to deliver to the client device in the Downlink (DL) and/or trigger client device for Uplink (UL) latency-sensitive traffic to meet QoS requirements for these traffic flows. For example, a client device 120 can indicate upcoming unavailability to any AP(s) 115 the client device 120 has a setup link with.

An AP 115 can determine whether there should be communications with the client device 120 during an unavailability period, for example based on the latency-sensitive traffic to be served during the unavailability period as described above. If there should be communications during an unavailability period, the AP 115 can request or otherwise instruct the client device 120 to communicate with the AP 115 on another link during the corresponding unavailability period. In some embodiments, when a client device is in active mode on a link, a PM (Power Management) bit is set to zero for that link and the client device can perform active transmit and receive operations on the link. When a client device is in a PS mode on a link, the PM bit is set to one for that link and the client device is typically in doze state on the link. In a PS mode (e.g., with the PM bit set to 1), the client device can still switch to an awake state and perform active transmit and receive operations on the link as well, without exiting the PS mode. In various embodiments, the AP 115 can signal to the client device 120 a policy to be awake on another link for communicating with the AP 115 during an unavailability period for a setup link via a Beacon, Probe Response, (Re)Association Response, and/or the like. The signal indicates to the client device 120 to always switch the other link to awake during an unavailability period or come out of PS mode explicitly, in certain embodiments. For example, the signal can indicate to switch a link to awake for both long term and Transmit Opportunity (TXOP) based unavailability. In some embodiments, the signal can indicate to switch a link to awake for one of the long term or the TXOP-based unavailability periods. The link can be switched to awake in two ways—either coming out of the PS mode explicitly by setting the PM bit to zero (e.g., using PM bit signaling) in which case the link becomes in active mode, or staying in PS mode (e.g., the PM bit remains set to one) but switching to an awake state while in power save mode such that the link is available for transmit and receive exchanges. The operation staying in the PS state may be an implicit switch to awake state by the client device on the link.

In other embodiments, the AP 115 can signal the client device 120 to make a link available for communication for specific periods of unavailability. The APs 115 and client devices 120 can negotiate the link on which the client device 120 will become awake during an unavailability period on another link. Referring to FIG. 2 for example, the AP 115 and client device 120 may primarily communicate via the first link 210 a and negotiate for the client device 120 to switch the second link 210 b to an awake mode (e.g., switch the STA2 205 b from a doze state to an awake state) during unavailability periods of the first link 210 a. The client device may still remain in the PS mode with PM bit set to one on the second link 210 b when it switches to awake state on that link during unavailability periods of the first link 210 a in some embodiments and switch from the PS mode to the active mode during unavailability periods.

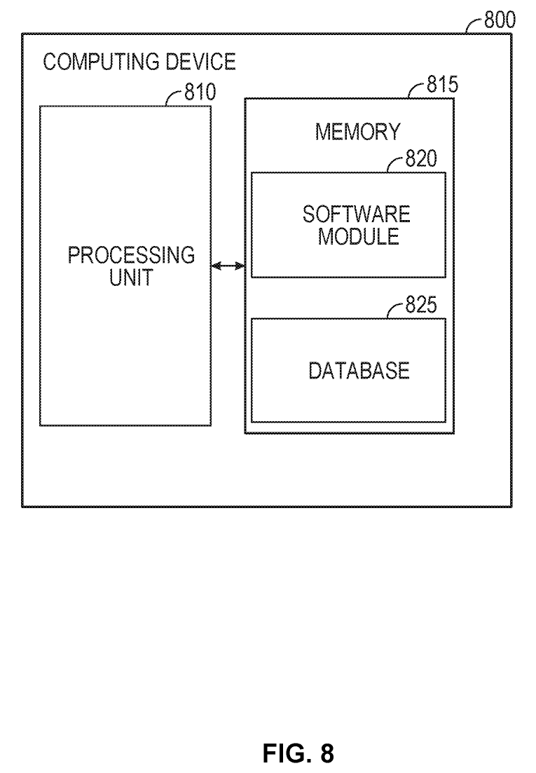

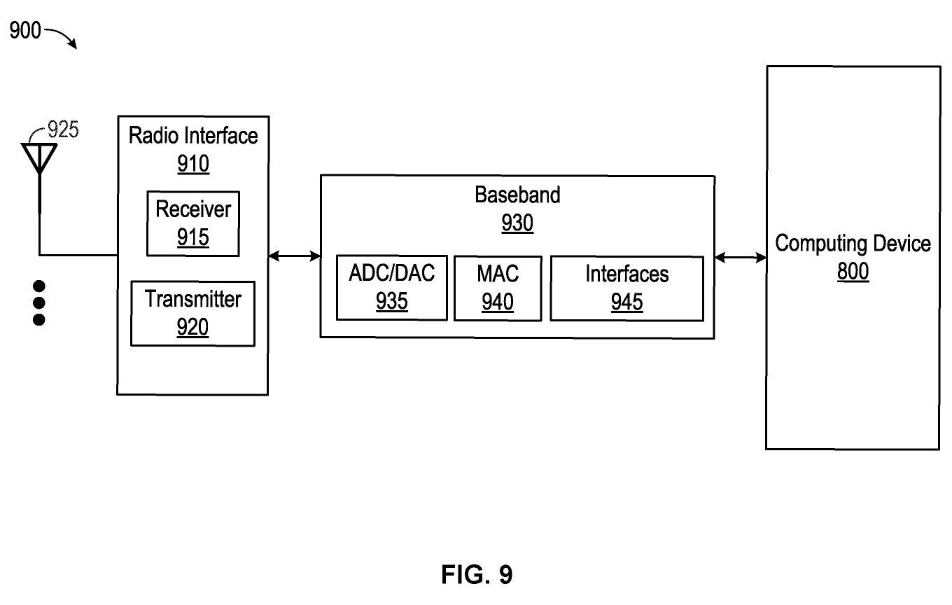

The elements described above of the operating environment 100 (e.g., the controller 105, the APs 115, the client devices 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 8 and 9, the elements of the operating environment 100 may be practiced in a computing device 800 and/or communications device 900.

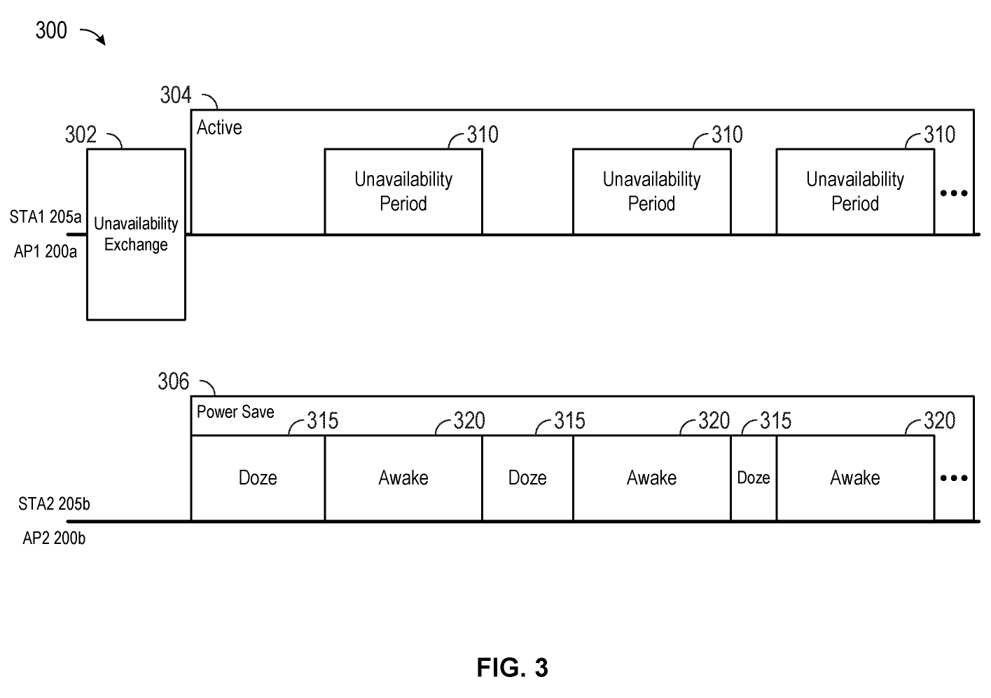

FIG. 3 is a signal process 300 of a client device switching a link out of PS doze state and into PS awake state during unavailability periods of a setup link. While not illustrated, the signal process 300 can comprise a client device 120 switching out of the PS mode during unavailability periods and back to the PS mode, similar to switching between the doze state and awake state. The signal process 300 includes an unavailability exchange 302, an active period 304 on the first link 210 a where the first link 210 a is in an active mode, and a PS period 306 on the second link 210 b where the second link 210 b is in a PS mode. The signal process 300 can include other amounts and combinations of links in further embodiments, such as the third link 210 c. For example, the client device 120 can switch the second link 210 b or the third link 210 c out of PS doze state and into PS awake state for different unavailability periods in example implementations. The third link 210 c can be switched out of PS mode entirely or out of the doze state for communications between the AP 115 and the client device 120 when the second link 210 b is being actively used for other communications, for instance. In one embodiment, the client device can switch the link completely out of PS mode during unavailability periods of a setup link, by setting the PM bit to zero and entering an active mode.

The unavailability exchange 302 between the AP 115 and the client device 120 establishes how the AP 115 and the client device 120 will operate during periods of unavailability and indicates to the AP 115 when unavailability periods 310 will occur. The unavailability exchange 302 can occur via any setup link between the AP 115 and the client device 120, such as the first link 210 a. In some embodiments, the unavailability exchange 302 comprises the exchange of request frames and response frames for negotiating the link set on which the client device 120 will come out of power save during unavailability periods 310, such as via the peer-to-peer target wait time (TWT) feature where Channel Usage Request and Response frames are extended.

In some embodiments, the unavailability exchange 302 includes only a request from an AP 115 to make a link available during unavailability periods 310 of the link the AP 115 is using to communicate with the client device. In further embodiments, the unavailability exchange 302 includes one or more responses from the client device 120 and/or further communications by the AP 115.

During the unavailability exchange 302, the client device 120 can indicate its unavailability (e.g., when the unavailability periods 310 will occur). The unavailability exchange 302 occurs at some predetermined time before upcoming unavailability. In certain embodiments, the client device 120 periodically indicates upcoming unavailability so APs 115 with one or more links to the client device 120 know when each unavailability period 310 will occur. The unavailability exchange 302 can also include the AP 115 signaling to the client device 120 how to operate during unavailability periods 310, such as switching another link to awake for communicating via the other link.

The unavailability exchange 302 can further include a negotiation or indication of which link or links the client device 120 will switch to awake during unavailability periods 310. The client device 120 can first indicate to the AP 115 one or more available links for switching out of PS for communication during unavailability periods 310. In some embodiments, the client device 120 uses a link identifier (ID) field of link ID bitmap to indicate the one or more available links. In certain embodiments, the client device 120 includes the link information based on an IDC policy advertised by the AP 115. The AP 115, in an accepted response frame for example, can signal a selected link on which it wants the client device 120 to use for communicating during the unavailability periods 310. In some embodiments, the AP 115 signals a link ID bitmap indicating multiple links the client device 120 can use, enabling the client device 120 to flexibly determine which link to switch out of PS mode during unavailability periods 310. For example, the links the link ID bitmap indicates can be the same set of links or a subset of the links the client device 120 provided to the AP 115 (e.g., in previously transmitted request frame). The unavailability exchange 302 can also include negotiating whether, during unavailability periods 310, the client device 120 stays in PS mode and switches to awake state on the negotiated other link(s) (e.g., the PM bit stays set to one) or the client device 120 explicitly switches out of PS mode (e.g., by sending a PM signaling that sets the PM bit to zero). In one embodiment, the client device 120 can indicate its preference to the AP 115 regarding its preferred mode of operation (between these two modes) during unavailability periods 310, and then in the response the AP 115 indicates its selected mode to be used. For example, a client device 120 may prefer to not require sending explicit signaling to set the PM bit to zero and hence may prefer to implicitly become awake while still in power save mode. This mode can be negotiated as part of the unavailability exchange 302.

In the illustrated embodiment, the unavailability exchange 302 results in the AP 115 and the client device 120 utilizing the second link 210 b during each unavailability period 310 of the first link 210 a. For example, the AP 115 indicates to the client device that it should have an available link during each unavailability period 310. Thus, the STA2 205 b of the second link 210 b is in a doze state 315 when the STA1 205 a on the first link 210 a is available (and active), and the STA2 205 b is in an awake state 320 during the unavailability periods 310 of STA1 205 a on the first link 210 a. The AP 115 and the client device 120 can then communicate via the second link 210 b during the awake state 320, and the client device 120 can resume conserving energy in the doze state 315 when the first link 210 a is available. In the illustrated embodiment, the client device remains in PS mode on link 210 b (with PM set to zero) and only switches from doze state 315 to awake state 320 (instead of fully coming out of the power save mode by setting the PM bit to zero).

In some embodiments, the client device may exit out of the PS mode on the second link 210 b during the unavailability periods 310 by signaling to set the PM bit to zero to switch out of power save mode. In such embodiments, the client device 120 can signal to the AP 115 which link is available for communicating during an unavailability period 310. For example, the STA2 205 b can send to the AP2 200 b a signal (e.g., a QoS Null signal) with the PM bit set to zero before or at the start of an unavailability period 310 to indicate to the AP 115 that the second link 210 b is available for communication during the respective unavailability period 310. The STA2 205 b can then send to the AP2 200 b another signal (e.g., a QoS Null signal) with the PM bit set to one to signal to the AP 115 the second link 210 b is unavailable (e.g., switching to the power save mode and doze state 315) when the respective unavailability period 310 is completed. The client device 120 can also perform the signaling for the second link 210 b to switch PS modes usingcross-link signaling (e.g., signal switching of power save modes from PM set to one to PM set to zero and then to PM set to one again on the first link 210 a).

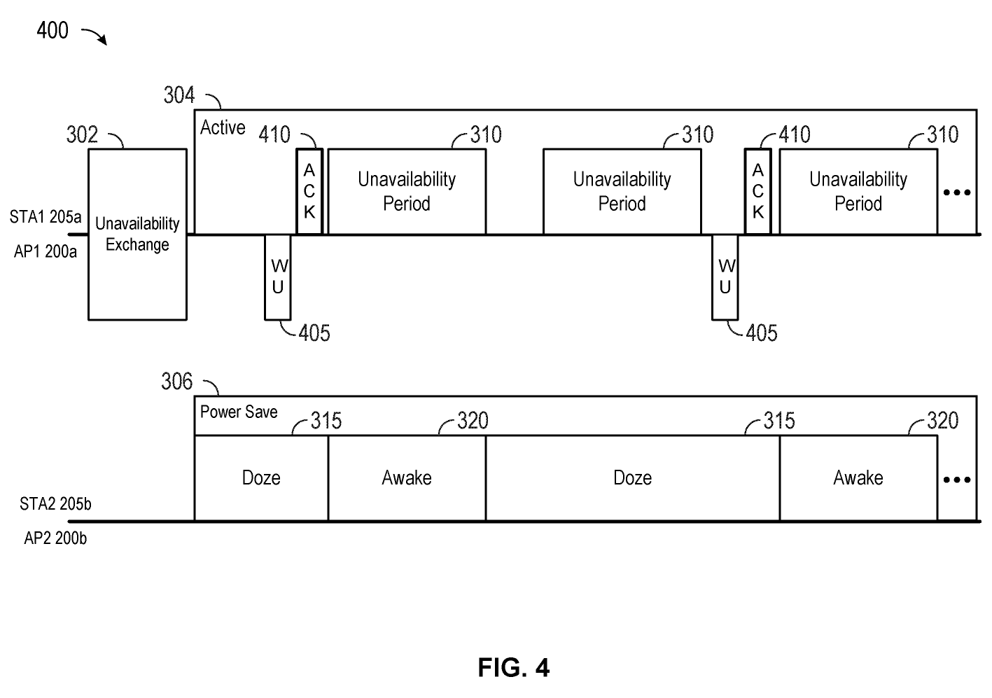

FIG. 4 is another signal process 400 of a client device 120 making another link available during unavailability periods of a setup. In the signal process 400, the unavailability exchange 302 results in the AP 115 and client device 120 determining to selectively switch another link to an awake state 320 for specific unavailability periods 310. Thus, the client device 120 can make a link available for communication in response to the AP 115 sending a wakeup request 405 before an unavailability period 310. The AP 115 can determine whether to send the wakeup request 405 before an unavailability period 310 based on buffered or expected DL traffic and/or expected UL traffic. For example, the AP 115 may send a wakeup request 405 before an unavailability period 310 to continue exchanging traffic with the client device 120 to meet QoS requirements (e.g., Stream Classification Service (SCS) QoS characteristics). If there is no buffered or expected traffic for the client device 120, the AP 115 may not send a wakeup request 405.

In some embodiments, the wakeup request 405 is signaled using a new A-Control field defined for Power Save Indication (PSI). The PSI A-Control field can be sent in-band in any DL frame (e.g., data frame, QoS Null). The PSI A-Control field can include a type which signals an 'awake request' (or awake but operate in low capability listen mode such as for EMLSR devices), a Link ID or a Link ID bitmap indicating one or more links requested to be available for the awake request, a flag indicating the one or more links to be available for entire unavailability period 310 on the identified link, a flag indicating the one or more links to be available for a portion of the unavailability period 310, and/or the like. In embodiments where the PSI A-Control field does not include a flag set to indicate how long the one or more links should be available, the client device may make the one or more links available for a default duration, such as a portion of the unavailability period 310 based on buffered traffic indication in the traffic indication map (TIM).

The client device 120 can send an acknowledge signal 410 to indicate to the AP 115 the wakeup request 405 was received. As shown in the illustrated embodiment, the client device 120 makes the second link 210 b available (e.g., switches the STA2 205 b from the doze state 315 to the awake state 320) in response to receiving a wakeup request 405. The second link 210 b remains unavailable (in doze state 315) when the client device 120 does not receive a wakeup request 405.

For an EMLSR supporting client device 120, the AP 115 can also request the client device 120 to be in listen only, low capability mode on one of the other links during an unavailability period 310, for example via the unavailability exchange 302. In some embodiments, the AP 115 requests the client device 120 to be in listen only mode on one of the other links via in-band PSI A-Control signaling. Similarly, if a client device 120 supports dynamic power save (DPS) operation where the client device 120 dynamically switches from low capability to high-capability mode of operation, then the AP 115 can request the client device 120 to be in low capability mode on one of the other links during an unavailability period 310.

A client device 120 with EMLSR mode on two links (e.g., 2.4 GHz and 5 GHz) can then be set in the awake state 320 but be in a listen only mode on the one link (e.g., 5 GHz link) when it has indicated unavailability on one of the other links (e.g., 2.4 GHz link). When an AP 115 has high priority pending traffic, the AP 115 can send an Initial Control Frame (ICF) indicating the traffic priority on the link in the listen only mode or to the link that will experience an unavailability period 310. The client device 120 can use the information of the ICF to determine whether to switch the link in the listen only mode to a full capability mode for transmitting and receiving on that link. If the client device 120 determines IDC or peer-to-peer traffic is more important and it can’t operate on the other link, the client device 120 may not respond to the ICF.

In one embodiment, if a client device 120 supports DPS operation, then the AP 115 can request the client device 120 to be in low capability mode on one of the other links during an unavailability period 310. Then the AP may exchange traffic with the client device in low capability mode on the other link.

In some embodiments, an AP 115 and a client device can establish a dynamic unavailability operation (DUO) for a TXOP-based unavailability reporting. Using DUO functionality, a client device 120 can indicate that it will be unavailable for a part of a TXOP, such as due to IDC or peer-to-peer traffic in an ICF (e.g., a BSRP Trigger frame) or an Initial Control Response (ICR) frame (e.g., a Multi-STA Block Acknowledge frame). Similar to the above processes, the AP 115 can advertise a policy that requires the client device 120 to make another link available if a setup link has an unavailability period 310 during the duration of a TXOP. In response, the client device 120 can make another link available for communications by coming out of power save mode or by switching a link to an awake state.

In certain embodiments, the AP 115 can explicitly request the client device 120 to make another link available when the AP 115 receives a short-term unavailability indication from the client device 120 in an ICF or an ICR. The AP 115 can send the ICF to the client device 120 at the start of TXOP when a DUO session is enabled. In some embodiments, the ICF is a Buffer Status Report Poll (BSRP) Trigger frame or a BSRP non-trigger based (NTB) trigger frame, which are control frames. In the ICF (e.g., BSRP Trigger frame or BSRP NTB trigger frame) or in a PSI Control field in the A-Control sent in a subsequent frame, the AP 115 can request the client device 120 to become awake (including in listen only mode for EMLSR STAs) on another link if the client device indicates TXOP-based unavailability to the AP. The signaling can request any link, a specific link ID, or a bitmap of links the AP 115 requests the client device 120 make available in a User Info field in the ICF. The User Info field in the ICF can also indicate specific ACs, Traffic IDs (TIDs), and/or SCS IDs (e.g., as a single value, a bitmap of values or a list of values per category) for which the AP 115 intends to serve the traffic on the other link(s) to meet QoS requirements for flows. The signaling may support a single category (e.g., TIDs only) or a top-level bitmap to indicate which one or more categories will be signaled (e.g., TID and SCS ID) in the ICF for which the AP 115 intends to serve the traffic on the other link(s).

Making the one or more links available may be dependent on the client device 120 responding with an ICR indicating unavailability for at least a portion of the TXOP. The ICR can be a Multi-STA Block Acknowledge control frame (Multi-STA BA frame) and can indicate whether the client device 120 accepts making one or more links available during the TXOP-based unavailability periods reported by the client device 120 and the link IDs for the links that will be made available. In some instances, the client device 120 may determine to come awake on one or more different links than what was requested by the AP 115 in the ICF, and these links are indicated in the ICR. One link may be indicated by a link ID, and multiple links may be indicated by a bitmap. In example implementations, the client device 120 may not need to transmit anything on the other indicated link(s) to indicate that the link is available (e.g., meaning the client device 120 will come out of doze state and transition to an awake state on the indicated link(s) without sending a signaling indicating the PM bit is set to zero).

By default, the client device 120 may be in an awake state on the other link for the part of the TXOP time duration for which it has indicated unavailability to the AP 115 in the ICR. APs 115 and client devices 120 can also indicate that they support cross-link wakeup on another link during IDC resulting in TXOP-based unavailability. An AP 115 can require this support as a prerequisite to accept and honor long-term and TXOP-based unavailability indications from the client devices 120. The wakeup request 405 (for another link) from AP 115 as described with respect to FIG. 4 can also be used by the AP 115 to wake up other link(s) when TXOP-based unavailability is reported by the client device. If the TXOP-based unavailability is reported by the client device in an ICF, then the AP 115 can send wakeup request for one or more other links as part of the ICR sent in response. If the TXOP-based unavailability is reported by the client device in an ICR, then the AP 115 can send wakeup request for one or more other links subsequently (e.g., in an A-Control field sent in a QoS null frame).

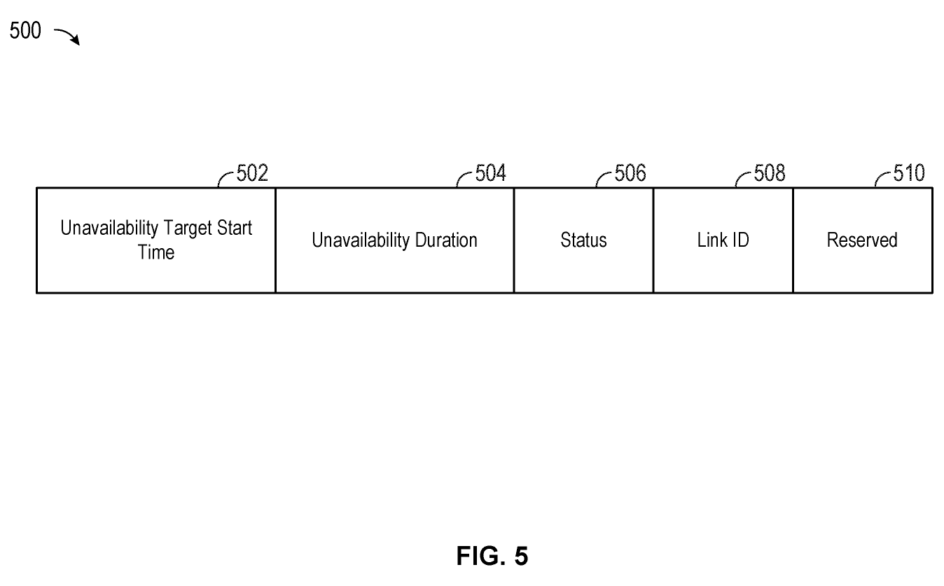

In certain embodiments, the ICR is a multi-STA block acknowledgement (BA) frame. FIG. 5 is a block diagram of an example ICR 500. The ICR 500 includes an unavailability target start time field 502, an unavailability duration field 504, a status field 506, a link ID field 508, and a reserved field 510. These fields can be included in a Feedback subfield of a multi-STA BA frame (e.g., in Feedback Per-AID TID field carried in the Multi-STA BA frame).

The ICR 500 can carry the response information (e.g., indicating accept/reject status of AP’s request and/or Link ID(s) or a Link ID bitmap indicating which links will be made available (e.g., which links will be made available). The unavailability target start time field 502 indicates the start time of an unavailability period 310 when there will be unavailability periods 310 during the associated TXOP. The unavailability duration field 504 indicates the duration of the unavailability period 310. The status field 506 indicates whether the client device 120 accepts or rejects the AP’s request to make one or more links available. The Link ID field 508 indicates a link the client device 120 will make available (e.g., including link IDs and/or a bitmap) during the respective unavailability period 310. In one embodiment, multiple Link IDs or a Link ID bitmap may be included to indicate multiple links that will become available during the unavailability period 310. The link ID field 508 may not be included if the one or more links that will be available are the same as the one or more links requested in the ICF or when the request is rejected.

In some embodiments, the inclusion of the link ID field 508 (or Link ID bitmap or set of Link IDs) also indicates acceptance of the request and no status field 506 is included. A presence bit may be used to indicate inclusion of the link ID field 508. Status field is included. In some embodiments, the client device can use a special Link ID (e.g., 15) in the link ID field 508 to indicate a rejection, and other values (e.g., 0-14) to indicate success.

In certain embodiments, an AP 115 uses the information from the ICR 500 (or other information from the client device 120 received during the unavailability exchange 302) to determine which link to use for communicating with the client device 120 during the upcoming unavailability periods 310. For example, if the client device 120 accepts the request, the ICR 500 indicates which link(s) the client device 120 will switch out of a doze state 315 to the awake state 320. Therefore, the client device 120 may not send an explicit/another signal to indicate which link is being made available for an upcoming unavailability period 310, and the AP 115 can determine the client device 120 will make the link(s) indicated in the ICR 500 available. In other embodiments, the client device 120 is required to signal and identify a link when the link is made available for communicating before every unavailability period 310. For example, the signal can be a QoS Null frame indicating the PM bit is set to zero or sent using cross-link PM signaling. In another embodiment, the behavior to send explicit signaling for the link to come out of power save or implicit transition to awake state on the other link can be selected dynamically for each unavailability period 310, selected at the session level (e.g., at association time), or selected after a negotiation (e.g., as part of unavailability exchange 302).

At the end of a TXOP or unavailability period 310, the client device 120 can resume communicating via the setup link and switch the other link back to a doze state 315 without signaling. In some embodiments, the client device 120 can indicate to the AP 115 to continue using the link that was switched to the awake state 320.

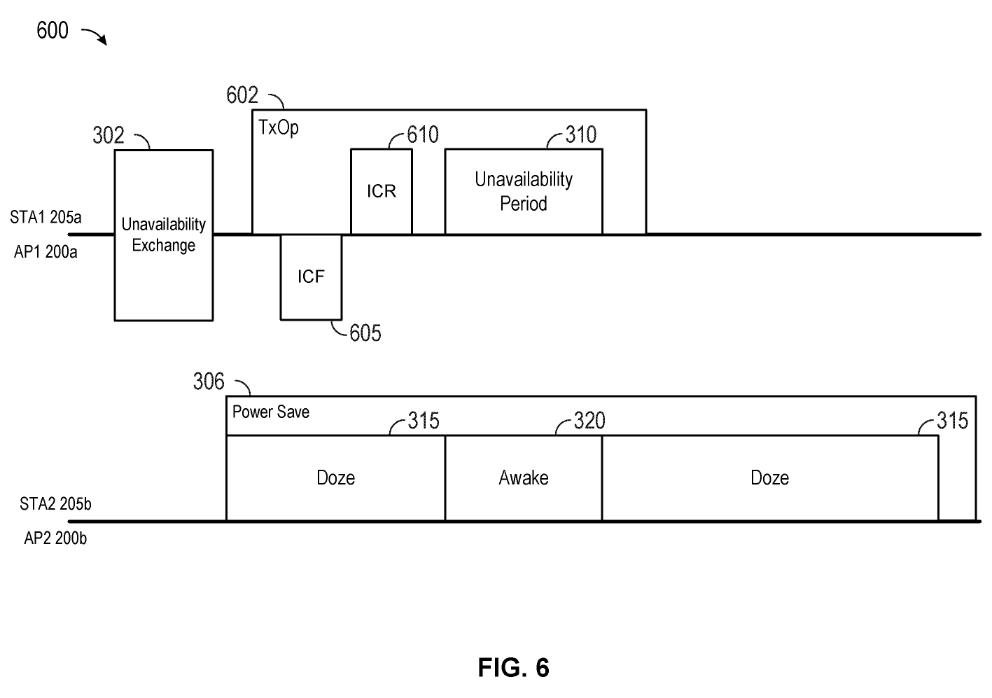

FIG. 6 is a signal process 600 of a client device switching a link to awake during unavailability periods of a setup link for a TXOP. During the unavailability exchange 302, the AP 115 and client device 120 establish that the AP 115 can request a link to be available during unavailability of a TXOP 602 using an ICF 605, and the client device 120 will report unavailability and accept the request during the TXOP 602 via an ICR 610 (e.g., having the form of the ICR 500). The unavailability exchange 302 can also be done at the time of association. In some embodiments, the unavailability exchange 302 is omitted, and the client device 120 and the AP 115 behave according to relevant standards and amendments. In the illustrated embodiment, the client device 120 makes the second link 210 b available and switches the STA2 205 b to an awake state 320. In some embodiments, the client device 120 will make the second link 210 b available after the unavailability period 310, such as until the end of the TXOP 602. The signal process 600 can also include any of the operations described above, such as the client device 120 sending a signal when the second link 210 b is made available.

In some embodiments, a client device 120 initiates a DUO. As described above, an AP 115 can signal information (e.g., information sent to the client device 120 during the unavailability exchange 302, a wakeup request 405, etc.) to the client device 120 using a PSI A-Control frame. In example embodiments, the AP 115 can send a PSI A-Control frame in response to receiving an ICR (e.g., the ICR 610). In other embodiments, the AP 115 can send information using an ICF such as a BSRP trigger frame. For example, the AP 115 can send an ICF indicating a link to make available or the like before or after the AP 115 receives an ICR.

In other embodiments, an AP 115 that initiates a TXOP can send a request to the client device 120 to make a link available (e.g., switch the respective STA to awake or out of PS mode) for cases when the client device 120 signals dynamic unavailability on the link being used for communication with the AP 115. The AP 115 can send the request as part of an ICF sent to the STA at the start of the TXOP when DUO is enabled, such as the ICF 605. The ICF used when DUO operation is enabled is a BSRP trigger frame (or a BSRP NTB trigger frame) in some implementations. As described herein, reference to a BSRP trigger frame in this can refer to either a BSRP trigger frame or a BSRP NTB trigger frame. In the BSRP trigger frame, the AP 115 can signal the request in a User Info field (which could be a special User Info field) targeted for the specific client device 120. The signal can indicate a specific link ID over which the AP 115 requests the client device 120 to switch a link to awake so it is available for communications between the AP 115 and the client device 120. The User Info field can also indicate specific TIDs, SCS IDs, and so on for which the AP 115 intends to serve the traffic on the other link to meet QoS requirements.

An AP 115 can send a BSRP trigger frame to multiple client devices 120 (e.g., to trigger UL-Orthogonal Frequency-Division Multiple Access (OFDMA)). For example, the AP 115 can send the BSRP trigger control frame to a group of ultra-high reliability (UHR) and non-UHR client devices 120.

In a BSRP trigger frame an AP 115 sends to one or more client devices for requesting availability on another link during periods of unavailability, a “TriggerDependentCommon” field and a “TriggerDependentUserInfo” field are both set to a Null value. Each User Info field of the BSRP trigger frame may be forty bits in length, and most of the defined bits in the User Info field are vital and cannot be redefined. However, the AP 115 can utilize one or more available bits for signaling. Additional fields can be included in the BSRP trigger frame, such as a single Special User Info field (SUIF) with a distinct Association ID (AID) for when the frame is sent unicast. The BSRP trigger frame can include an extra SUIF per client device 120, identified by setting MSB or MSB-1 of the AID field therein to one (e.g., so STA with AID = 10 also looks for 10+2048 or 10+1024). In some embodiments, the BSRP trigger frame includes multiple SUIF (e.g., one SUIF per user) using a defined special user info AID for this kind of SUIF, and the AID of the intended recipient of the SUIF is inferred based on the order of AIDs earlier in the Trigger frame. Each client device may have its own SUIF.

In some embodiments, the BSRP trigger frame includes multiple special user info fields, with multiple users packed into each SUIF (forty bits - SUIF AID = twenty-eight "payload" bits). The BSRP trigger frame can include a defined special user info AID for this kind of SUIF, and the AID of the intended recipient of the user field is inferred based on the order of AIDs earlier in the Trigger frame. In example implementations, each client device 120 has a seven-bit field in a SUIF.

In some embodiments, the reserved bit in the normal User Info field is used as a "Presence bit" to flag if a client device 120 has an extra SUIF as described herein or an extra field (e.g., seven bits in length) in the extra SUIFs as described above. Client devices 120 can use the “Presence bits" to determine which fields include information for the respective client device 120.

In certain embodiments, instead of one well-known AID value for the SUIFs, a range of four or sixteen (e.g., 2010 to 2025) AID values are utilized. Ten or eight bits are therefore used for AID and/or SUIF identification. The BSRP trigger frame can therefore include 28+2 or 28+4 payload bits (e.g., so the frame can fit five client devices 120 having six associated bits, six client devices 120 having five associated bits, eight client devices 120 having four associated bits, or four client devices 120 having eight associated bits). These SUIFs might be used for DUO-related signaling but also as a container for other per-client device 120 signaling in BSRP Trigger frames.

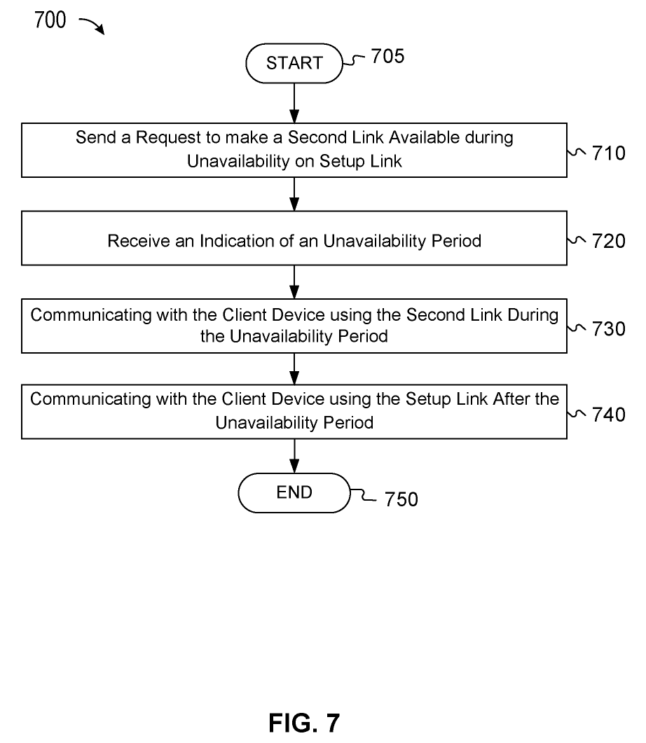

FIG. 7 is a block diagram of a method 700 for indicating and negotiating for a client device 120 to make a link available during unavailability on a setup link. The method 700 may begin at starting block 705 and proceed to operation 710. In operation 710, a request is sent to a client device to make a second link available when the client device is unavailable on a first link. For example, an AP 115 sends a request to a client device 120. The client device 120 may be configured to switch a STA 205 associated with the second link from a doze state to an awake state. The request can be sent during an unavailability exchange in example implementations.

In operation 720, the AP 115 receives an indication of an unavailability period on the first link. For example, the client device 120 indicates upcoming unavailability periods during the unavailability exchange or using some other signaling before the unavailability period.

In operation 730, the AP 115 communicates with the client device 120 via the second link during the unavailability period because the client device has set the second link into an awake state and the first link is unavailable. In operation 740, the AP 115 communicates with the client device 120 via the first link after the unavailability period.

In some embodiments, the method 700 includes sending to the client device 120 a wakeup request before the unavailability period, wherein the client device 120 is configured to switch the STA 205 associated with the second link from the doze state to the awake state in response to the wakeup request. The wakeup request can comprise a PSI A-Control field that includes a type signaling how the client device 120 should operate during an unavailability period, a link ID or link bitmap indicating the second link and/or one or more additional links, a flag indicating a period to make the second link available during unavailability, and/or the like.

In some embodiments, the method 700 comprises determining not to send a wakeup request before a second unavailability period, wherein the client device 120 is configured to maintain the STA 205 associated with the second link in the doze state in response to not receiving the wakeup request, and communicating with the client device using the first link during the second unavailability period. The method 700 can also include sending an ICF during a TXOP indicating to the client device 120 to make the second link available when the client device is unavailable on the first link during the TXOP, receiving an ICR indicating the client device will make the second link available during a second unavailability period during the TXOP, and communicating with the client device 120 using the second link during the second unavailability period. The method 700 can also include receiving, from the client device 120, a response to the request, wherein the response identifies the second link the client device 120 will make available during unavailability. The method 700 can include receiving from the client device an ICF indicating a second unavailability period on the first link, sending to the client device an ICR indicating to the client device to make the second link available during the second unavailability period, and communicating with the client device using the second link during the second unavailability period. In some embodiments, the method 700 includes receiving from the client device an ICR indicating a third unavailability period on the first link, sending to the client device a wakeup request before the third unavailability period, wherein the client device is configured to switch the STA associated with the second link from the doze state to the awake state in response to the wakeup request, and communicating with the client device using the second link during the third unavailability period. The ICF is a BSRP trigger frame or a BSRP NTB trigger frame in example implementations. The ICR is a multi-STA BA frame in certain embodiments. The method 700 can include sending the request to the client device 120 for a set of periodic unavailability periods reported by the client device 120 or for dynamic unavailability periods reported by the client device 120. The method 700 concludes at ending block 750.

FIG. 8 is a block diagram of a computing device 800. As shown in FIG. 8, computing device 800 may include a processing unit 810 and a memory unit 815. Memory unit 815 may include a software module 820 and a database 825. While executing on processing unit 810, software module 820 may perform, for example, processes for providing indications and negotiating for a device to come out of power save with respect to FIGS. 1-7. Computing device 800, for example, may provide an operating environment for the controller 105, the APs 115, the client devices 120, and the like may operate in other environments and are not limited to computing device 800.

Computing device 800 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 800 may comprise any computer operating environment, such as hand-held devices, multiprocessor systems, microprocessor-based or programmable sender electronic devices, minicomputers, mainframe computers, and the like. Computing device 800 may also be practiced in distributed computing environments where tasks are performed by remote processing devices. The aforementioned systems and devices are examples, and computing device 800 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 800 on the single integrated circuit (chip).

FIG. 9 illustrates an implementation of a communications device 900 that may implement one or more of the controller 105, the APs 115, the client devices 120, etc., of FIGS. 1-7. In various implementations, the communications device 900 may comprise a logic circuit. The logic circuit may include physical circuits to perform operations described for one or more of the controller 105, the APs 115, the client devices 120, etc., of FIGS. 1-7, for example. As shown in FIG. 9, the communications device 900 may include one or more of, but is not limited to, a radio interface 910, baseband circuitry 930, and/or the computing device 800.

The communications device 900 may implement some or all of the structures and/or operations for the controller 105, the APs 115, the client devices 120, etc., of FIGS. 1-7, storage medium, and logic circuit in a single computing entity, such as entirely within a single device. Alternatively, the communications device 900 may distribute portions of the structure and/or operations using a distributed system architecture, such as a client station server architecture, a peer-to-peer architecture, a master-slave architecture, etc.

A radio interface 910, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 910 may include, for example, a receiver 915 and/or a transmitter 920. The radio interface 910 may include bias controls, a crystal oscillator, and/or one or more antennas 925. In additional or alternative configurations, the radio interface 910 may use oscillators and/or one or more filters, as desired.

The baseband circuitry 930 may communicate with the radio interface 910 to process, receive, and/or transmit signals and may include, for example, an Analog-To-Digital Converter (ADC) for down converting received signals with a Digital-To-Analog Converter (DAC) 935 for up converting signals for transmission. Further, the baseband circuitry 930 may include a baseband or PHYsical layer (PHY) processing circuit for the PHY link layer processing of respective receive/transmit signals. Baseband circuitry 930 may include, for example, a MAC processing circuit 940 for MAC/data link layer processing. Baseband circuitry 930 may include a memory controller for communicating with MAC processing circuit 940 and/or a computing device 800, for example, via one or more interfaces 945.

In some configurations, PHY processing circuit may include a frame construction and/or detection module, in combination with additional circuitry such as a buffer memory, to construct and/or deconstruct communication frames. Alternatively or in addition, MAC processing circuit 940 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
sending to a client device a request to make a second link available when the client device is unavailable on a first link, wherein the client device is configured to make the second link available;
receiving an indication of an unavailability period on the first link;
communicating with the client device using the second link during the unavailability period; and
communicating with the client device using the first link after the unavailability period.

2. The method of claim 1, wherein the client device making the second link available comprises the client device:
switching a Station (STA) associated with the second link to an awake state; or
switching the STA associated with the second link out of a power save mode.

3. The method of claim 1, wherein the client device is configured to:
switch a STA associated with the second link from an awake state to a doze state after the unavailability period; or
switch the STA associated with the second link to power save mode.

4. The method of claim 1, further comprising:
sending to the client device a wakeup request before the unavailability period, wherein the client device is configured to switch a STA associated with the second link from a doze state to an awake state in response to the wakeup request.

5. The method of claim 4, wherein the wakeup request comprises a power save indication (PSI) A-Control field including any one of (i) a type signaling how the client device should operate during unavailability, (ii) a link identifier (ID) indicating the second link, (iii) link bitmap indicating the second link and one or more additional links, (iv) a flag indicating a period to make the second link available during unavailability, or (v) any combination of (i)-(iv).

6. The method of claim 4, further comprising:
determining not to send the wakeup request before a second unavailability period, wherein the client device is configured to maintain the STA associated with the second link in the doze state in response to not receiving the wakeup request.

7. The method of claim 1, further comprising:
sending to the client device an initial control frame (ICF) during a Transmit Opportunity (TXOP) indicating to the client device to make the second link available when the client device is unavailable on the first link during the TXOP;
receiving an initial control response (ICR) indicating the client device will make the second link available during a second unavailability period during the TXOP; and
communicating with the client device using the second link during the second unavailability period.

8. The method of claim 1, further comprising:
receiving, from the client device, a response to the request, wherein the response identifies the second link the client device will make available during unavailability.

9. A system comprising:
a memory storage; and
a processing unit coupled to the memory storage, wherein the processing unit is operative to:
send to a client device a request to make a second link available when the client device is unavailable on a first link, wherein the client device is configured to make the second link available;
receiving an indication of an unavailability period on the first link;
communicating with the client device using the second link during the unavailability period; and
communicating with the client device using the first link after the unavailability period.

10. The system of claim 9, wherein the client device making the second link available comprises:
switching a Station (STA) associated with the second link to an awake state; or
switching the STA associated with the second link out of a power save mode.

11. The system of claim 9, the processing unit being further operative to:
send to the client device a wakeup request before the unavailability period, wherein the client device is configured to switch a STA associated with the second link from a doze state to an awake state in response to the wakeup request.

12. The system of claim 11, wherein the wakeup request comprises a power save indication (PSI) A-Control field including any one of (i) a type signaling how the client device should operate during unavailability, (ii) a link identifier (ID) indicating the second link, (iii) link bitmap indicating the second link and one or more additional links, (iv) a flag indicating a period to make the second link available during unavailability, or (v) any combination of (i)-(iv).

13. The system of claim 9, the processing unit being further operative to:
determine not to send a wakeup request before a second unavailability period, wherein the client device is configured to maintain a STA associated with the second link in a doze state in response to not receiving the wakeup request.

14. The system of claim 9, the processing unit being further operative to:
receive, from the client device, a response to the request, wherein the response identifies the second link the client device will make available during unavailability.

15. A non-transitory computer-readable medium that stores a set of instructions which when executed perform a method executed by the set of instructions comprising:
sending to a client device a request to make a second link available when the client device is unavailable on a first link, wherein the client device is configured to switch a Station (STA) associated with the second link from a doze state to an awake state;
receiving an indication of an unavailability period on the first link;
communicating with the client device using the second link during the unavailability period; and
communicating with the client device using the first link after the unavailability period.

16. The non-transitory computer-readable medium of claim 15, wherein:
the client device is configured to switch the STA associated with the second link from the awake state to the doze state after the unavailability period.

17. The non-transitory computer-readable medium of claim 15, the method executed by the set of instructions further comprising:
sending to the client device a wakeup request before the unavailability period, wherein the client device is configured to switch the STA associated with the second link from the doze state to the awake state in response to the wakeup request.

18. The non-transitory computer-readable medium of claim 15, the method executed by the set of instructions further comprising:
determining not to send a wakeup request before a second unavailability period, wherein the client device is configured to maintain the STA associated with the second link in the doze state in response to not receiving the wakeup request; and
communicating with the client device using the first link during the second unavailability period.

19. The non-transitory computer-readable medium of claim 15, the method executed by the set of instructions further comprising:
sending to the client device an initial control frame (ICF) during a Transmit Opportunity (TXOP) indicating to the client device to make the second link available when the client device is unavailable on the first link during the TXOP;
receiving an initial control response (ICR) indicating the client device will make the second link available during a second unavailability period during the TXOP; and
communicating with the client device using the second link during the second unavailability period.

20. The non-transitory computer-readable medium of claim 15, the method executed by the set of instructions further comprising:
receiving, from the client device, a response to the request, wherein the response identifies the second link the client device will make available during unavailability.
